(19) United States
(12) Patent Application Publication
(10) Pub. No.: US 2026/0359093 A1
(43) Pub. Date: Nov. 12, 2026

(54) METHOD AND APPARATUS FOR CONSTRUCTING HYBRID VIRTUAL DEVICE

(71) Applicants: GREE ELECTRIC APPLIANCES, INC. OF ZHUHAI, Zhuhai (CN); EDGELESS SEMICONDUCTOR CO., LTD. OF ZHUHAI, Zhuhai (CN)

(72) Inventor: Wenfeng LIU, Zhuhai (CN)

(73) Assignees: GREE ELECTRIC APPLIANCES, INC. OF ZHUHAI, Zhuhai (CN); EDGELESS SEMICONDUCTOR CO., LTD. OF ZHUHAI, Zhuhai (CN)

(21) Appl. No.: 19/718,333

(22) Filed: Jun. 24, 2026

Related U.S. Application Data
(63) Continuation of application No. PCT/CN2024/121991, filed on Sep. 27, 2024.

(30) Foreign Application Priority Data
Dec. 25, 2023 (CN) 202311799980.1

(51) Int. Cl. G06F 9/455; G06F 9/445

(52) U.S. Cl. CPC G06F 9/45558; G06F 9/44505; G06F 2009/45562

(57) ABSTRACT

A method for constructing a hybrid virtual device includes: determining a data source type and determining a starting input and output module based on the data source type; determining a functional module; determining an output data type and determining a terminal input and output module based on the output data type; adopting the starting input and output module, the functional module, and the terminal input and output module to generate a plurality of independent virtual devices; and adopting the plurality of independent virtual devices to construct the hybrid virtual device.

### CROSS-REFERENCE TO RELATED APPLICATIONS

The present application is a continuation application of International Application No. PCT/CN2024/121991, filed on Sep. 27, 2024, which claims priority to Chinese Patent Application No. 202311799980.1, filed on Dec. 25, 2023. The disclosures of the above-mentioned applications are hereby incorporated by reference in their entireties.

### TECHNICAL FIELD

The present disclosure relates to the field of hybrid virtual device construction technologies, and in particular, to a method for constructing a hybrid virtual device, and an apparatus for constructing a hybrid virtual device.

### BACKGROUND

A functional module on a chip is attached as a slave device to a chip bus and accessed by a processor via an input/output instruction. With increasing generality and integration of chips, the number of functional modules is gradually increasing. However, an excessive number of devices on the bus reduces access efficiency. Furthermore, for specific applications, many device modules remain unused, resulting in significant redundancy and an increase in chip area.

### SUMMARY

Embodiments of the present disclosure provide a method and an apparatus for constructing a hybrid virtual device, an electronic device, and a computer-readable storage medium to overcome or at least partially solve the aforementioned problems.

The embodiments of the present disclosure disclose the method for constructing the hybrid virtual device, which includes:
determining a data source type and determining a starting input/output module based on the data source type;
determining a functional module;
determining an output data type and determining a terminal input/output module based on the output data type;
adopting the starting input/output module, the functional module, and the terminal input/output module to generate a plurality of independent virtual devices; and
adopting the plurality of independent virtual devices to construct the hybrid virtual device.

Optionally, the method further includes:
constructing a data source module configuration parameter table, an intermediate node module configuration parameter table, and a data sink module configuration parameter table for the plurality of independent virtual devices;
determining a data source module configuration parameter for the starting input/output module, and writing the data source module configuration parameter into the data source module configuration parameter table;
when the functional module is a peripheral module, determining an intermediate node module configuration parameter for expressing an input/output data format of the functional module, and writing the intermediate node module configuration parameter into the intermediate node module configuration parameter table;
determining a data sink module configuration parameter for the terminal input/output module, and writing the data sink module configuration parameter into the data sink module configuration parameter table; and
starting the hybrid virtual device.

Optionally, the hybrid virtual device is provided with a bus arbiter, each the plurality of independent virtual devices is provided with a corresponding device identifier, the functional module is provided with a corresponding input data buffer memory, and the method further includes:
when input data for a target virtual device is detected, reading a target data source module configuration parameter corresponding to the target virtual device from the data source module configuration parameter table based on a target device identifier corresponding to the target virtual device;
determining a target functional module corresponding to the target virtual device based on the target device identifier;
acquiring the input data based on the target data source module configuration parameter; and
storing the input data into a target input data buffer memory corresponding to the target functional module via the bus arbiter.

Optionally, the method further includes:
acquiring a status parameter for the target input data buffer memory;
when it is determined based on the status parameter that a storage amount of the target input data buffer memory exceeds a first preset threshold, adjusting the target functional module up to a first frequency using a primary frequency multiplication coefficient;
when it is determined based on the status parameter that a storage amount of the target input data buffer memory exceeds a second preset threshold, adjusting the target functional module up to a second frequency using a secondary frequency multiplication coefficient, where the second frequency is higher than the first frequency; and
when it is determined based on the status parameter that a storage amount of the target input data buffer memory exceeds a third preset threshold, adjusting the target functional module up to a highest frequency using a tertiary frequency multiplication coefficient.

Optionally, the target functional module is configured with a corresponding pipeline configuration table, and the method further includes:
when the target functional module finishes processing the input data, sending output request information to the bus arbiter, where the output request information at least includes the target device identifier and output packet length information for a data packet of the input data;
determining a next-level functional module identifier of a next-level functional module corresponding to the target functional module in the pipeline configuration table via the bus arbiter based on the target device identifier and a target functional module identifier of a currently requesting target functional module, where the next-level functional module has a corresponding to-be-processed data sequence, the to-be-processed data sequence is used for expressing an order of input data to be processed by the target functional module; and the input data has a corresponding priority identifier;
inserting the input data into the to-be-processed data sequence via the bus arbiter based on the priority identifier; and
storing the input data into a next-level input data buffer memory corresponding to the next-level functional module via the bus arbiter based on the to-be-processed data sequence.

Optionally, the functional module is provided with an input port and an output port, and the functional module is connected to the input data buffer memory via the input port and the output port.

Optionally, the functional module is configured with a corresponding state machine, and the method further includes:
determining whether the input data buffer memory is empty; and
if it is determined that the input data buffer memory is not empty, performing a reset operation on the state machine.

The embodiments of the present disclosure further provide an apparatus for constructing a hybrid virtual device, which includes:
a data source type determination module, configured to determine a data source type and determine a starting input/output module based on the data source type;
a functional module determination module, configured to determine a functional module;
an output data type determination module, configured to determine an output data type and determine a terminal input/output module based on the output data type;
an independent virtual device generation module, configured to adopt the starting input/output module, the functional module, and the terminal input/output module to generate a plurality of independent virtual devices; and
a hybrid virtual device construction module, configured to adopt the plurality of independent virtual devices to construct the hybrid virtual device.

The embodiments of the present disclosure further provide an electronic device, which includes a processor, a communication interface, a memory, and a communication bus, where the processor, the communication interface, and the memory communicate with each other via the communication bus;
the memory is configured to store a computer program; and
the processor is configured to, when executing the program stored on the memory, implement the method according to the embodiments of the present disclosure.

The embodiments of the present disclosure further provide a computer-readable storage medium storing instructions, where the instructions, when executed by one or more processors, cause the processor to execute the method according to the embodiments of the present disclosure.

The embodiments of the present disclosure include following advantages.

In the embodiments of the present disclosure, by determining the data source type and determining the starting input/output module based on the data source type; determining the functional module; determining the output data type and determining the terminal input/output module based on the output data type; adopting the starting input/output module, the functional module, and the terminal input/output module to generate the plurality of independent virtual devices; and adopting the plurality of independent virtual devices to construct the hybrid virtual device, the virtual device implements specific device functions on a chip, thereby reducing device redundancy.

### BRIEF DESCRIPTION OF THE DRAWINGS

FIG. 1 is a flowchart of steps of a method for constructing a hybrid virtual device according to an embodiment of the present disclosure.

FIG. 2 is a schematic structural diagram of an independent virtual device according to an embodiment of the present disclosure.

FIG. 3 is a schematic flowchart of a user registering a virtual device according to an embodiment of the present disclosure.

FIG. 4 is a schematic structural diagram of a functional module according to an embodiment of the present disclosure.

FIG. 5 is a schematic diagram illustrating a relationship between storage thresholds and frequency multiplication levels for a functional module according to an embodiment of the present disclosure.

FIG. 6 is a schematic structural diagram of a bus arbiter according to an embodiment of the present disclosure.

FIG. 7 is a schematic flowchart of a reset operation for a state machine according to an embodiment of the present disclosure.

FIG. 8 is a schematic flowchart of a scheduling process based on a bus arbiter according to an embodiment of the present disclosure.

FIG. 9 is a structural block diagram of an apparatus for constructing a hybrid virtual device according to an embodiment of the present disclosure.

FIG. 10 is a hardware structural block diagram of an electronic device according to an embodiment of the present disclosure.

FIG. 11 is a schematic diagram of a computer-readable medium according to an embodiment of the present disclosure.

### DETAILED DESCRIPTION OF THE EMBODIMENTS

To make the above objectives, features, and advantages of the present disclosure more comprehensible, the present disclosure is described below in further detail with reference to drawings and specific embodiments.

In practical applications, a virtual device is configured to implement specific device functions on a chip to reduce the number of devices, and also to improve flexibility of use when a plurality of channels and various types of devices are needed. To further effectively reduce device redundancy, the embodiments of the present disclosure provide a hybrid virtual device, which improves device scalability and enables efficient utilization of functional modules.

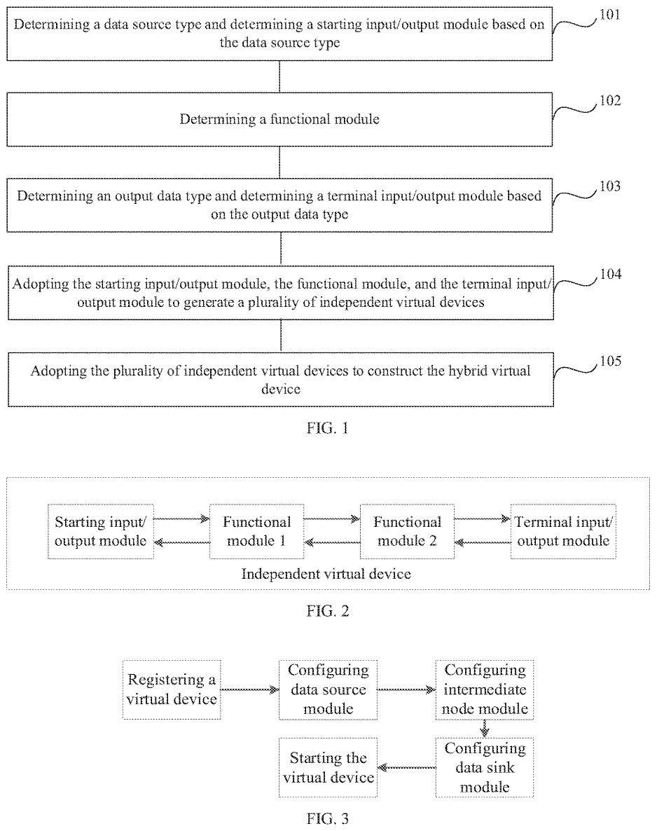

With reference to FIG. 1, a flowchart of steps of a method for constructing a hybrid virtual device according to an embodiment of the present disclosure is shown, which may specifically include following steps.

Step 101: determining a data source type and determining a starting input/output module based on the data source type.

Step 102: determining a functional module.

Step 103: determining an output data type and determining a terminal input/output module based on the output data type.

Step 104: adopting the starting input/output module, the functional module, and the terminal input/output module to generate a plurality of independent virtual devices.

Step 105: adopting the plurality of independent virtual devices to construct the hybrid virtual device.

The hybrid virtual device may be composed of the plurality of independent virtual devices. Therefore, to construct the hybrid virtual device, this embodiment of the present disclosure may firstly generate the independent virtual devices.

GPIO is an abbreviation for General-Purpose Input/Output. Its function is similar to P0 to P3 of 8051. Its pins may be freely programmed and controlled by users. Depending on practical considerations, each pin may be configured as general-purpose input (GPI), general-purpose output (GPO), or general-purpose input/output (GPIO), for example, it can serve as a clock generator, chip select, or the like.

Direct Memory Access (DMA) is a feature provided by some computer bus architectures that enables data to be sent directly from a peripheral device (such as a disk drive) to a main memory on a computer motherboard.

With reference to FIG. 2, FIG. 2 is a schematic structural diagram of an independent virtual device according to an embodiment of the present disclosure, the independent virtual device in this embodiment may be composed of a starting input/output module (a starting input and output module), one or more functional modules, and a terminal input/output module (a terminal input and output module). Among these, a module closest to the starting input/output module may be a first-level functional module, a next closest to the starting input/output module may be a second-level functional module, and so on. This embodiment may combine a plurality of functional modules using a data pipeline approach to form a plurality of independent virtual devices. Optionally, different virtual devices may use the same functional module. For example, if two virtual devices both require an encryption/decryption operation on input/output data, these two virtual devices may share the same encryption/decryption functional module at different time periods. Start and end points of a stream are input/output modules, for example. a GPIO chip pin input/output module (a GPIO chip pin input and output module) and a DMA memory input/output module (a DMA memory input and output module). A data flow direction between the functional modules may be unidirectional or bidirectional.

Once a structure of the independent virtual device is determined, the independent virtual device may be generated based on the structure.

In a specific implementation, this embodiment may determine the data source type, and based on the data source type, the starting input/output module is determined. The functional module is determined according to actual business requirements. The output data type is determined, and based on the output data type, the terminal input/output module is determined. Thus, the independent virtual device is determined via the starting input/output module, the functional module, and the terminal input/output module. Moreover, the plurality of independent virtual devices may be used for constructing the hybrid virtual device.

Exemplarily, with reference to FIG. 3, FIG. 3 is a schematic flowchart of a user registering a virtual device according to an embodiment of the present disclosure.

A user applies for a virtual device number from a virtual device manager. The virtual device manager reserves a virtual device identifier for a virtual device in a virtual device pipeline configuration table.

Static Random-Access Memory (SRAM) is a type of random-access memory. The term “static” means that as long as power is maintained, data stored in this memory may be kept constant. In contrast, data stored in Dynamic Random-Access Memory (DRAM) needs to be refreshed periodically. However, when power supply is interrupted, the data stored in SRAM is still lost (such memory is referred to as volatile memory), which is different from ROM or flash memory that may retain data after power loss.

The starting input/output module is used for sampling a data source, and therefore it may also be regarded as a data source module. A user may determine a virtual device data source module in the following manner.

If source data is obtained by sampling from chip pins via GPIO, meaning the data source type is GPIO data, then a chip pin input/output module is used as the starting input/output module.

If the source data is obtained from system SRAM, meaning the data source type is SRAM data, then a DMA memory input/output module is used as the starting input/output module.

The functional module may also be regarded as an intermediate node module. The functional module may be determined according to actual business requirements, for example, an encryption/decryption data processing module for performing an encryption/decryption operation on data.

The terminal input/output module may be used for data output, and therefore it may also be regarded as a data sink module. A user may determine the data sink module in the following manner.

If data is output through GPIO from chip pins, meaning the output data type is GPIO data, then the chip pin input/output module may be used as the terminal input/output module.

If the source data is obtained from the system SRAM, meaning the output data type is SRAM data, then the DMA memory input/output module is used as the terminal input/output module.

In an optional embodiment of the present disclosure, when there is no data sink module, the hybrid virtual device may be configured on a processor, such as a central processing unit (CPU), and the like. The processor may be configured with an input/output bus, and the processor may retrieve output data from a status parameter table of a last-level functional module in the independent virtual device via the input/output bus.

After completing construction of the hybrid virtual device, the hybrid virtual device may be started. At this point, the hybrid virtual device processes the input data obtained from the data source module stage by stage under the scheduling of the virtual device manager, and results are placed in an input data buffer memory of the data sink module, and an interrupt signal is sent to the processor according to user configuration.

Certainly, the above examples are for illustration only. For instance, those skilled in the art may replace manual selection with preset rule code, and the present embodiments do not impose limitations thereon.

In this embodiment, by determining the data source type and determining the starting input/output module based on the data source type; determining the functional module; determining the output data type and determining the terminal input/output module based on the output data type; adopting the starting input/output module, the functional module, and the terminal input/output module to generate the plurality of independent virtual devices; and adopting the plurality of independent virtual devices to construct the hybrid virtual device, the virtual device implements specific device functions on the chip, thereby reducing device redundancy.

Based on the above embodiments, variant embodiments of the above embodiments are proposed. It should be noted that, to keep description concise, only differences from the above embodiments are described in the variant embodiments.

In an optional embodiment of the present disclosure, the method further includes:
constructing a data source module configuration parameter table, an intermediate node module configuration parameter table, and a data sink module configuration parameter table for the independent virtual device;
determining a data source module configuration parameter for the starting input/output module, and writing the data source module configuration parameter into the data source module configuration parameter table;
when the functional module is a peripheral module, determining an intermediate node module configuration parameter for expressing an input/output (input and output) data format of the functional module, and writing the intermediate node module configuration parameter into the intermediate node module configuration parameter table;
determining a data sink module configuration parameter for the starting input/output module, and writing the data sink module configuration parameter into the data sink module configuration parameter table; and
starting the hybrid virtual device.

Exemplarily, with reference to FIG. 3, FIG. 3 is a schematic flowchart of a user registering a virtual device according to an embodiment of the present disclosure.

A user applies for a virtual device number from a virtual device manager. The virtual device manager reserves a virtual device identifier for the virtual device in a virtual device pipeline configuration table.

The starting input/output module is used for sampling the data source, and therefore it may also be regarded as a data source module. A user may configure the virtual device data source module in the following manner:
constructing a data source module configuration parameter table, an intermediate node module configuration parameter table, and a data sink module configuration parameter table for the independent virtual device;
if source data is obtained by sampling from chip pins via GPIO, meaning the data source type is GPIO data, then using a chip pin input/output module as the starting input/output module, and writing the data source module configuration parameters such as a sampling clock source, a clock frequency, and a filtering coefficient into the data source module configuration parameter table for the virtual device; and
if the source data is obtained from system SRAM, meaning the data source type is SRAM data, then using a DMA memory input/output module as the starting input/output module, writing the data source module configuration parameters such as a data input address, a data length, a buffer threshold, and an interrupt (interrupt signal) into the data source module configuration parameter table for the virtual device, and simultaneously, inserting a first-level functional module node for the virtual device identifier of the virtual device into the virtual device pipeline configuration table.

A full English name of SPI is Serial Peripheral Interface, which, as the name suggests, is a serial peripheral interface. SPI is a synchronous serial communication interface specification, mainly used for short-distance communication in embedded systems.

Universal Asynchronous Receiver/Transmitter (UART) is an asynchronous transceiver, which is a portion of computer hardware that transmits data via serial communication. It performs parallel-to-serial data conversion at a transmitting end and serial-to-parallel data conversion at a receiving end. It is universal because parameters such as transmission speed and data speed are configurable. UART is commonly used in connections with other communication interfaces, such as EIA RS-232.

I2C bus is a simple, bidirectional, two-wire synchronous serial bus. It requires only two wires to transmit information between devices connected to the bus. A master device is used for initiating data transfer on the bus and generating a clock to enable the transfer. At this time, any addressed device is considered a slave device. Relationships of master and slave, transmitter and receiver on the bus are not constant but depend on a data transfer direction at any given time. If the master needs to send data to a slave device, the master firstly addresses the slave device, then actively sends data to the slave device, and finally terminates the data transfer. If the master needs to receive data from a slave device, the master firstly addresses the slave device, then receives the data sent by the slave device, and finally terminates the receiving process. In this case, the master is responsible for generating a timing clock and terminating data transfer.

The functional module may also be regarded as the intermediate node module. The functional module may be determined according to actual business requirements, for example, an encryption/decryption data processing module for performing an encryption/decryption operation on data. A user may configure the functional module in the following manner: if the functional module is a peripheral module such as SPI/UART/I2C, the intermediate node module configuration parameter used for expressing the input/output data format for the functional module, for example, the I2C byte format, the bit address format, and the like, may be used as the intermediate node module configuration parameters and written into the intermediate node module configuration parameter table for the virtual device. Simultaneously, an identifier of the functional module for the virtual device is inserted into the virtual device pipeline configuration table.

The terminal input/output module may be used for data output, and therefore it may also be regarded as a data sink module. A user may configure the data sink module in the following manner:
if data is output via GPIO from chip pins, meaning the output data type is GPIO data, then the chip pin input/output module may be used as the terminal input/output module; and the data sink module configuration parameters such as output clock source and clock frequency are written into the data sink module configuration parameter table for the data sink module of the virtual device; and
if the source data is obtained from the system SRAM, meaning the data source type is SRAM data, then the DMA memory input/output module is used as the terminal input/output module, and the data sink module configuration parameters such as data output address, length, buffer threshold, and interrupt are written into the data sink module configuration parameter table for the data sink module.

In an optional embodiment of the present disclosure, when there is no data sink module, the hybrid virtual device may be configured on a processor, such as a central processing unit (CPU), and the like. The processor may be configured with an input/output bus, and the processor may retrieve output data from a status parameter table of a last-level functional module in the independent virtual device via the input/output bus.

After completing construction of the hybrid virtual device, the hybrid virtual device may be started. At this point, the hybrid virtual device processes the input data obtained from the data source module stage by stage under the scheduling of the virtual device manager, and results are placed in an input data buffer memory of the data sink module, and an interrupt signal is sent to the processor according to user configuration.

In an optional embodiment of the present disclosure, the hybrid virtual device is provided with a bus arbiter, the independent virtual device is provided with a corresponding device identifier, and the functional module is provided with a corresponding input data buffer memory. The method further includes:
when input data for a target virtual device is detected, reading a target data source module configuration parameter corresponding to the target virtual device from the data source module configuration parameter table based on a target device identifier corresponding to the target virtual device;
determining a target functional module corresponding to the target virtual device based on the target device identifier;
acquiring the input data based on the target data source module configuration parameter; and
storing the input data into a target input data buffer memory corresponding to the target functional module via the bus arbiter.

Optionally, the functional module is equipped with an input port and an output port. The functional module is connected to the input data buffer memory via the input port and the output port.

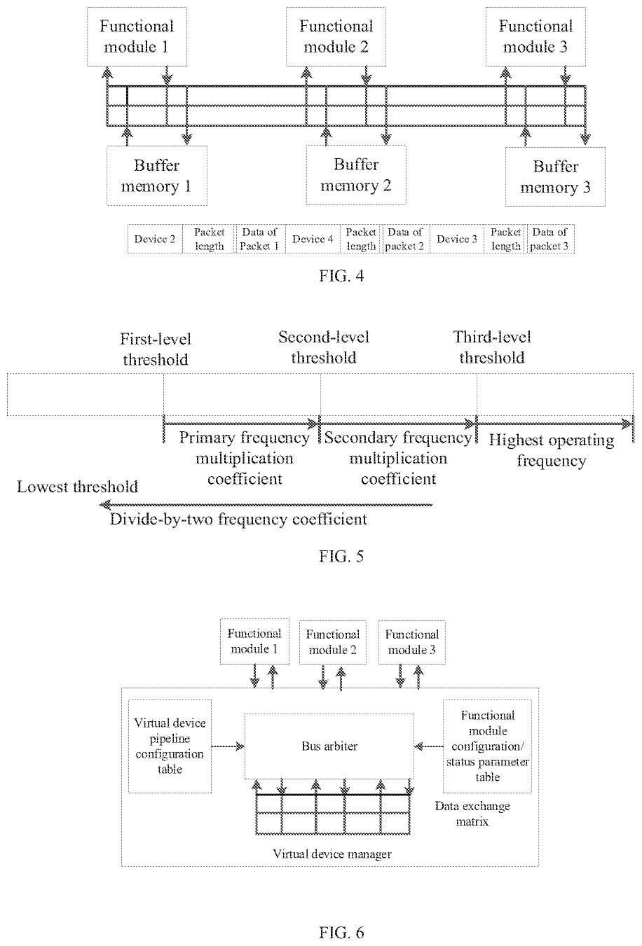

With reference to FIG. 4, FIG. 4 is a schematic structural diagram of a functional module according to an embodiment of the present disclosure. A one-to-one correspondence may exist between the plurality of functional modules and the plurality of input data buffer memories. The input ports and the output ports of the plurality of functional modules, together with the plurality of input data buffer memories or registers, form a data exchange matrix to transmit data in a form of byte stream or bit stream. Data in a data buffer area uses a hybrid storage approach. Data packets from a plurality of virtual devices enter a buffer area in sequence. The virtual device identifier is used as a preamble for the input data packet.

In a specific implementation, the bus arbiter may be a device used to determine which data is processed first by a module when a plurality of data packets point to the same module. Each independent virtual device may be configured with a unique device identifier. It may be understood that the target device identifier may be an identifier used to mark the target virtual device. When input data for the target virtual device is detected, the target data source module configuration parameter corresponding to the target virtual device may be read from the data source module configuration parameter table based on the target device identifier corresponding to the target virtual device. The target data source module configuration parameter may be used for sampling the data source. The target device identifier may also be used for determining the target functional module corresponding to the target virtual device, that is, the functional module required by the target virtual device when processing actual business. Subsequently, the input data is stored into the target input data buffer memory corresponding to the target functional module via the bus arbiter.

This embodiment implements input/output data buffer management for the hybrid virtual device. The input ports and the output ports of the plurality of functional modules of the device, together with a plurality of data buffer static memories or registers, form the data exchange matrix to transmit data in the form of byte stream or bit stream. Data packets from different virtual devices are stored in a mixed manner, and are identified and distinguished by packet preamble device identifiers.

In an optional embodiment of the present disclosure, the method further includes:
acquiring a status parameter for the target input data buffer memory;
when it is determined based on the status parameter that a storage amount of the target input data buffer memory exceeds a first preset threshold, adjusting the target functional module up to a first frequency using a primary frequency multiplication coefficient;
when it is determined based on the status parameter that a storage amount of the target input data buffer memory exceeds a second preset threshold, adjusting the target functional module up to a second frequency using a secondary frequency multiplication coefficient, where the second frequency is higher than the first frequency; and
when it is determined based on the status parameter that a storage amount of the target input data buffer memory exceeds a third preset threshold, adjusting the target functional module up to a highest frequency using a tertiary frequency multiplication coefficient.

In practical applications, a frequency multiplication coefficient refers to a relative proportional relationship between a main frequency and an external frequency of a CPU.

With reference to FIG. 5, FIG. 5 is a schematic diagram illustrating a relationship between storage thresholds and frequency multiplication levels for a functional module according to an embodiment of the present disclosure, this embodiment may adjust an operating frequency of each functional module based on an input data speed of the input data buffer memory corresponding to the functional module, and a three-level threshold mechanism is adopted. When data in an input buffer area of the functional module increases to the first preset threshold, the primary frequency multiplication coefficient is applied; when the data in the input buffer area of the functional module increases to the second preset threshold, the secondary frequency multiplication coefficient is applied; when the data in the input buffer area of the functional module increases to the third preset threshold, the highest operating frequency is applied; and when the data in the input buffer area of the functional module decreases to the next-level threshold, a divide-by-two frequency reduction coefficient is uniformly applied until the lowest threshold is reached.

Specifically, a virtual device manager may be configured for the hybrid virtual device. The virtual device manager may be a management system for the hybrid virtual device. The status parameter of the target input data buffer memory is obtained via the virtual device manager, and the status of an input data buffer memory of each functional module is monitored based on the status parameter to prevent overflow and data loss.

When the data in the input buffer area of the target functional module increases to the first preset threshold, the virtual device manager uses the primary frequency multiplication coefficient to adjust the target functional module up to the first frequency until the data in the target input data buffer memory stops growing.

When the data in the input buffer area of the target functional module increases to the second preset threshold, the virtual device manager uses the secondary frequency multiplication coefficient to adjust the target functional module up to the second frequency until the data in the target input data buffer memory stops growing.

When the data in the input buffer area of the target functional module increases to the third preset threshold, the virtual device manager uses the tertiary frequency multiplication coefficient to adjust the target functional module up to the third frequency until the data in the target input data buffer memory overflows.

In an optional embodiment of the present disclosure, when the data in the input buffer area of the target functional module decreases, the virtual device manager may use the divide-by-two frequency coefficient of the target functional module to reduce frequency until the data in the target input data buffer memory stops decreasing or reaches the lowest threshold or a minimum operating frequency of the target functional module is achieved.

In this embodiment, the status parameter of the target input data buffer memory is acquired; when it is determined based on the status parameter that the storage amount of the target input data buffer memory exceeds the first preset threshold, the primary frequency multiplication coefficient is used to increase the frequency of the target functional module to the first frequency; when it is determined based on the status parameter that the storage amount of the target input data buffer memory exceeds the second preset threshold, the secondary frequency multiplication coefficient is used to increase the frequency of the target functional module to the second frequency, where the second frequency is higher than the first frequency; and when it is determined based on the status parameter that the storage amount of the target input data buffer memory exceeds the third preset threshold, the tertiary frequency multiplication coefficient is used to increase the frequency of the target functional module to the highest frequency. This enables the virtual device manager to adaptively adjust the operating frequency of each functional module based on the input data speed of each functional module, thereby achieving a balance between power consumption and throughput.

In an optional embodiment of the present disclosure, the target functional module is configured with a corresponding pipeline configuration table, and the method includes:
when the target functional module finishes processing the input data, sending output request information to the bus arbiter, where the output request information at least includes the target device identifier and output packet length information;
determining a next-level functional module identifier of a next-level functional module corresponding to the target functional module in the pipeline configuration table via the bus arbiter based on the target device identifier and a target functional module identifier of a currently requesting target functional module, where the next-level functional module has a corresponding to-be-processed data sequence, the to-be-processed data sequence is used for expressing an order of input data to be processed by the target functional module; and the input data has a corresponding priority identifier;
inserting the input data into the to-be-processed data sequence via the bus arbiter based on the priority identifier; and
storing the input data into a next-level input data buffer memory corresponding to the next-level functional module via the bus arbiter based on the to-be-processed data sequence.

With reference to FIG. 6, FIG. 6 is a schematic structural diagram of a bus arbiter according to an embodiment of the present disclosure.

In a specific implementation, the embodiments of the present disclosure utilize the data exchange matrix and the bus arbiter to realize the virtual device manager. The bus arbiter references pipeline configuration information of each virtual device and, based on a virtual device identifier, a device priority, and a functional module identifier output by the current request, directs the output data into an input buffer of the next-level functional module in the pipeline.

When the target functional module finishes processing the input data, the output request information may be sent to the bus arbiter. The output request information at least includes the target device identifier and output packet length information for a data packet of the input data. Based on the target device identifier and the target functional module identifier of the currently requesting target functional module, the bus arbiter may look up the next-level functional module identifier of the next-level functional module corresponding to the target functional module from the pipeline configuration table. A to-be-processed data sequence may be configured for the next-level functional module, and the to-be-processed data sequence is used to express the order of the input data to be processed by the target functional module. The input data has the corresponding priority identifier. Based on the priority identifier, the bus arbiter may insert the input data into the to-be-processed data sequence. Finally, based on the to-be-processed data sequence, the bus arbiter stores the input data into the next-level input data buffer memory corresponding to the next-level functional module.

For example, when the plurality of independent virtual devices simultaneously request the bus arbiter for output to the same next-level functional module for data processing, data from the plurality of independent virtual devices are queued into the to-be-processed data sequence. Input data with higher priority may be placed before input data with lower priority and be processed first by the next-level functional module.

In the embodiments of the present disclosure, each functional module may have its input data buffer memory designated by software. Based on configuration of each virtual device, the data bus arbiter transmits output data of a functional module to the input data buffer memory of a next functional module via the data exchange matrix, and data from a high-speed virtual device is prioritized for processing according to user-specified priority levels, thereby achieving a high-throughput, low-latency scheduling operation mode for the functional module.

In an optional embodiment of the present disclosure, the functional module is configured with a corresponding state machine, and the method further includes:
determining whether the input data buffer memory is empty; and
if it is determined that the input data buffer memory is not empty, performing a reset operation on the state machine.

In practical applications, a state machine refers to a finite-state machine (FSM), also known as a finite-state automaton (FSA). It is a mathematical computational model representing a finite number of states, and transitions, actions, and other behaviors between these states.

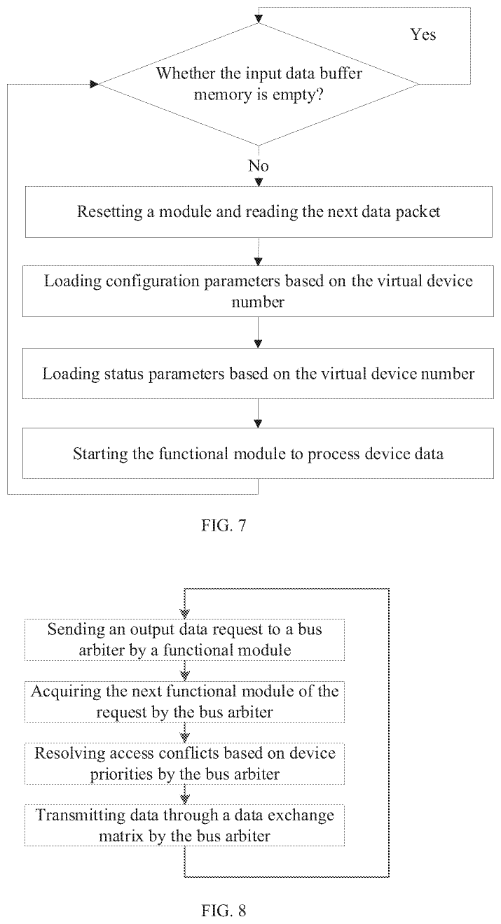

With reference to FIG. 7, FIG. 7 is a schematic flowchart of a reset operation for a state machine according to an embodiment of the present disclosure. Before storing the input data into the target input data buffer memory corresponding to the target functional module via the bus arbiter, it may be determined whether the input data buffer memory is empty. If it is determined that the input data buffer memory is not empty, a reset operation is performed on the state machine to complete initialization of the state machine.

To make a person skilled in the art better understand the embodiments of the present disclosure, a complete example is described below to illustrate the embodiments of the present disclosure.

As shown in FIG. 2, the plurality of functional modules are combined using a data pipeline approach to form the plurality of hybrid virtual devices. Different virtual devices may use a same functional module (for example, if two virtual devices both require encryption/decryption operations on input/output data, they may time-share the same encryption/decryption functional module). A start point and an end point of a stream are input/output modules, such as the GPIO chip pin input/output module and the DMA memory input/output module. A data flow direction between the functional modules may be unidirectional or bidirectional.

As shown in FIG. 3, the input ports and the output ports of the plurality of functional modules, together with the plurality of data buffer static memories or registers, form the data exchange matrix, to transmit the data in the form of byte stream or bit stream. The data in the data buffer area uses a hybrid storage approach, the data packets from the plurality of virtual devices enter the buffer area in sequence, and the virtual device identifier is used as a packet preamble.

As shown in FIG. 7, switching between hybrid virtual devices is performed based on the device identifier in the input data, which includes four steps: resetting a module and reading the next data packet, loading configuration parameters based on the virtual device identifier, loading status parameters based on the virtual device identifier, and starting the functional module to process device data.

As shown in FIG. 6, the virtual device manager is implemented using the data exchange matrix and the bus arbiter. The bus arbiter references the virtual device pipeline configuration information of each virtual device and, based on the device identifier, the device priority, and the functional module identifier output by the current request, directs the output data into the input buffer of the next-level functional module in the pipeline.

As shown in FIG. 5, the operating frequency of each functional module is adjusted based on the speed of its input data, and the three-level threshold mechanism is adopted. When the data in the input buffer area of the functional module increases to the first-level threshold, the primary frequency multiplication coefficient is applied; when it increases to the second-level threshold, the secondary frequency multiplication coefficient is applied; when it increases to the third-level threshold, the highest operating frequency is applied; and when it decreases to the next-level threshold, the divide-by-two frequency reduction coefficient is uniformly applied until the lowest threshold is reached.

As shown in FIG. 3, the configuration of a data pipeline for the hybrid virtual device may be implemented in the following manner.

The user applies for the virtual device identifier from the virtual device manager. The virtual device manager reserves the virtual device identifier in the virtual device pipeline configuration table.

The user configures the data source module for the virtual device:
if the source data is obtained by sampling from chip pins via GPIO, the chip pin input/output module is adopted, and configuration parameters such as the sampling clock source, the clock frequency, and the filter coefficient are written into the configuration parameter table of the data source module of the virtual device; and
if the source data is obtained from the system SRAM, the DMA memory input/output module is adopted, and configuration parameters such as the data input address, length, buffer threshold, and interrupt are written into the configuration parameter table of the data source module of the virtual device. Simultaneously, the first-level functional module node corresponding to the virtual device identifier is inserted into the virtual device pipeline configuration table.

The user configures parameters of the intermediate node module of the virtual device:
if the functional module is the peripheral module such as SPI/UART/I2C, parameters like the input/output data format are configured and written into a configuration parameter table of this node module of the virtual device. Simultaneously, the functional module identifier of the virtual device is inserted into the virtual device pipeline configuration table.

The user configures parameters of the data sink module:
if the data is output via GPIO from chip pins, the chip pin input/output module is adopted, and configuration parameters such as the output clock source and the clock frequency are written into the configuration parameter table of the data sink module of the virtual device; and
if the data is output to the system SRAM, the DMA memory input/output module is adopted, and configuration parameters such as the data output address, length, buffer threshold, and interrupt are written into a configuration parameter table of this data sink module. Simultaneously, a last-level functional module node corresponding to the virtual device identifier is inserted into the virtual device pipeline configuration table. There may be no data sink module, and in this case, the processor directly retrieves data from the status parameter table of the last-level functional module of the virtual device via the input/output bus.

The virtual device is started, at this point, the virtual device processes the input data obtained from the source data module stage by stage under the scheduling of the virtual device manager, places the results in the input buffer of the data sink module, and sends an interrupt to the processor according to the user configuration.

As shown in FIG. 7, device switching for the functional module may be performed as follows:
when it is determined that the input data buffer memory of the functional module is not empty, the state machine of the functional module is reset, and the data packet is read in simultaneously, where the functional module reads configuration parameters of this level module of the virtual device from the configuration parameter table based on the virtual device identifier.
the functional module reads status parameters of this level module of the virtual device from the status parameter table based on the virtual device identifier; and
the functional module starts processing the data packet and sends the result to the bus arbiter, which then transmits the result to the input data buffer of the next-level module.

As shown in FIG. 5, adaptive frequency switching for the functional modules by the virtual device manager may be implemented as follows:
the virtual device manager monitors the status of the input data buffer of each functional module to prevent overflow and data loss;
when the data in the input buffer area of the functional module increases to the first-level threshold, the virtual device manager applies the primary frequency multiplication coefficient to increase the frequency of the functional module until the data in the input buffer area stops growing;
when the data in the input buffer area of the functional module increases to the second-level threshold, the virtual device manager applies the secondary frequency multiplication coefficient to increase the frequency of the functional module until the data in the input buffer area stops growing;
when the data in the input buffer area of the functional module increases to the third-level threshold, the virtual device manager applies the highest operating frequency of the functional module until the data in the input buffer area overflows; and
when the data in the input buffer area of the functional module decreases, the virtual device manager applies the divide-by-two frequency coefficient of the functional module to reduce the frequency until the data in the input buffer area stops decreasing, or reaches a minimum threshold, or a minimum operating frequency of the module is already reached.

As shown in FIG. 8, FIG. 8 is a schematic flowchart of a scheduling process based on a bus arbiter according to an embodiment of the present disclosure. Scheduling by the bus arbiter in the virtual device manager may be performed as follows:
after finishing processing current input data, the functional module sends an output request to the bus arbiter, where the output request includes information such as the virtual device identifier and an output packet length;
based on the virtual device identifier and the currently requesting functional module identifier, the bus arbiter looks up the pipeline configuration table to obtain the next-level functional module identifier;
if a plurality of devices simultaneously request the bus arbiter for output to the input buffer memory of the same functional module, the bus arbiter selects a device based on device priorities;
the bus arbiter switches corresponding switches of the data exchange matrix to deliver the output data of the device to the input buffer of the next-level functional module in the form of a byte stream or a bit stream; and
the bus arbiter re-executes the step of looking up the pipeline configuration table based on the virtual device identifier and the currently requesting functional module identifier to obtain the next-level functional module identifier.

Through the above methods, the functional modules are combined using a data pipeline to implement the hybrid virtual device, and virtual device operation scheduling is performed via the data exchange matrix and the bus arbiter. This not only significantly improves operational efficiency of each functional module, but also increases flexibility of device channel expansion and functional expansion. At the same time, redundant chip area is reduced, chip costs are lowered, and achieves a balance between power consumption and throughput.

It should be noted that for method embodiments, they are described as a series of action combinations for simplicity. However, those skilled in the art should understand that the embodiments of the present disclosure are not limited by a described order of actions, as according to the embodiments of the present disclosure, certain steps may be performed in other orders or simultaneously. Furthermore, those skilled in the art should also understand that the embodiments described in the specification are all preferred embodiments, and actions involved are not necessarily required for the embodiments of the present disclosure.

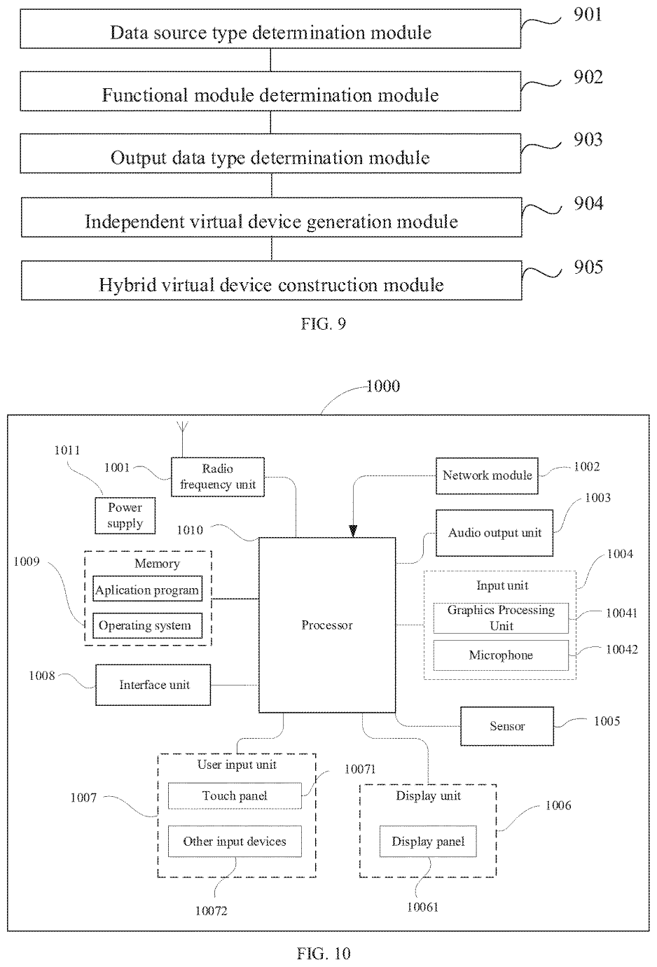

With reference to FIG. 9, a structural block diagram of an apparatus for constructing a hybrid virtual device according to an embodiment of the present disclosure is shown, which may specifically include following modules:
a data source type determination module 901, configured to determine a data source type and determine a starting input/output module based on the data source type;
a functional module determination module 902, configured to determine a functional module;
an output data type determination module 903, configured to determine an output data type and determine a terminal input/output module based on the output data type;
an independent virtual device generation module 904, configured to adopt the starting input/output module, the functional module, and the terminal input/output module to generate a plurality of independent virtual devices; and
a hybrid virtual device construction module 905, configured to adopt the plurality of independent virtual devices to construct the hybrid virtual device.

For apparatus embodiments, since they are basically similar to the method embodiments, the description is relatively simple. For relevant parts, reference may be made to the description of the method embodiments.

In addition, the embodiments of the present disclosure further provide an electronic device, which includes: a processor, a memory, and a computer program stored on the memory and executable on the processor. When the computer program is executed by the processor, various processes of the method for constructing the hybrid virtual device in the above embodiments are implemented, and same technical effects are achieved. To avoid repetition, details are not repeated herein.

Th embodiments of the present disclosure further provide a computer-readable storage medium. A computer program is stored on the computer-readable storage medium. When the computer program is executed by a processor, the various processes of the method for constructing the hybrid virtual device in the above embodiments are implemented, and same technical effects are achieved. To avoid repetition, details are not repeated herein. The computer-readable storage medium includes, for example, Read-Only Memory (ROM), Random Access Memory (RAM), magnetic disks, or optical discs, or the like.

FIG. 10 is a schematic diagram of a hardware structure of an electronic device for implementing various embodiments of the present disclosure.

The electronic device 1000 includes, but is not limited to: a radio frequency unit 1001, a network module 1002, an audio output unit 1003, an input unit 1004, a sensor 1005, a display unit 1006, a user input unit 1007, an interface unit 1008, a memory 1009, a processor 1010, and a power supply 1011. Those skilled in the art may understand that the electronic device structure shown in FIG. 10 does not constitute a limitation on the electronic device. The electronic device may include more or fewer components than shown, or combine some components, or have a different arrangement of components. In the embodiments of the present disclosure, the electronic device includes, but is not limited to, a mobile phone, a tablet computer, a laptop, a handheld computer, a vehicle-mounted terminal, a wearable device, and a pedometer.

It should be understood that in the embodiments of the present disclosure, the radio frequency unit 1001 may be used for receiving and sending signals during information transmission or a call process. Specifically, after receiving downlink data from a base station, it is processed by the processor 1010; and additionally, uplink data is sent to the base station. Typically, the radio frequency unit 1001 includes, but is not limited to, an antenna, at least one amplifier, a transceiver, a coupler, a low noise amplifier, a duplexer, and the like. Furthermore, the radio frequency unit 1001 may also communicate with networks and other devices via a wireless communication system.

The electronic device provides users with wireless broadband internet access via the network module 1002, such as helping users send and receive emails, browse web pages, and access streaming media.

The audio output unit 1003 may convert audio data received by the radio frequency unit 1001 or the network module 1002, or stored in the memory 1009, into audio signals and output them as sound. Moreover, the audio output unit 1003 may also provide audio output (for example, call signal reception sound, message reception sound, or the like) related to specific functions performed by the electronic device 1000. The audio output unit 1003 includes a speaker, a buzzer, a receiver, and the like.

The input unit 1004 is used for receiving audio or video signals. The input unit 1004 may include a Graphics Processing Unit (GPU) 10041 and a microphone 10042. The GPU 10041 processes image data of static pictures or videos obtained by an image capture device (such as a camera) in a video capture mode or an image capture mode. Processed image frames may be displayed on the display unit 1006. Image frames processed by the GPU 10041 may be stored in the memory 1009 (or other storage media) or transmitted via the radio frequency unit 1001 or the network module 1002. The microphone 10042 may receive sound, and process the sound into audio data. The processed audio data may be converted into a format suitable for transmission to a mobile communication base station via the radio frequency unit 1001 in a telephone call mode.

The electronic device 1000 also includes at least one type of sensors 1005, such as a light sensor, a motion sensor, and other sensors. Specifically, the light sensor includes an ambient light sensor and a proximity sensor. The ambient light sensor may adjust brightness of a display panel 10061 according to brightness of ambient light. The proximity sensor may turn off the display panel 10061 and/or backlight when the electronic device 1000 is moved close to an ear. As a type of motion sensors, an accelerometer sensor may detect magnitude of acceleration in various directions (generally three axes), and may detect magnitude and direction of gravity when stationary, which may be used for recognizing electronic device posture (such as horizontal/vertical screen switching, related games, magnetometer posture calibration), vibration recognition related functions (such as pedometer, tapping), and the like. The sensor 1005 may also include a fingerprint sensor, a pressure sensor, an iris sensor, a molecular sensor, a gyroscope, a barometer, a hygrometer, a thermometer, an infrared sensor, and the like, which are not detailed herein.

The display unit 1006 is used for displaying information input by the user or information provided to the user. The display unit 1006 may include a display panel 10061, which may be configured using forms such as a Liquid Crystal Display (LCD) or an Organic Light-Emitting Diode (OLED).

The user input unit 1007 may be used for receiving input numeric or character information, and generating key signal inputs related to user settings and functional control of the electronic device. Specifically, the user input unit 1007 includes a touch panel 10071 and other input devices 10072. The touch panel 10071, also known as a touchscreen, may collect touch operations (such as operations performed by the user using any suitable object or accessory like a finger or stylus on or near the touch panel 10071) performed by the user on or near it. The touch panel 10071 may include two parts: a touch detection device and a touch controller. The touch detection device detects a touch position of the user and a signal generated by the touch operation, and transmits the signal to the touch controller. The touch controller receives touch information from the touch detection device, converts it into touch point coordinates, and sends it to the processor 1010 and receives and executes commands from the processor 1010. Furthermore, the touch panel 10071 may be implemented using various types such as resistive, capacitive, infrared, and surface acoustic wave. In addition to the touch panel 10071, the user input unit 1007 may also include other input devices 10072. Specifically, other input devices 10072 may include, but are not limited to, a physical keyboard, function keys (such as a volume control key, a power key, and the like), a trackball, a mouse, and a joystick, which will not be repeated herein.

Furthermore, the touch panel 10071 may be overlaid on the display panel 10061. When the touch panel 10071 detects a touch operation on or near it, it transmits information to the processor 1010 to determine a type of a touch event. Subsequently, the processor 1010 provides corresponding visual output on the display panel 10061 based on the type of the touch event. Although in FIG. 10, the touch panel 10071 and the display panel 10061 are implemented as two independent components to achieve input and output functions of the electronic device, in some embodiments, the touch panel 10071 and the display panel 10061 may be integrated to achieve the input and output functions of the electronic device. Specific details are not limited herein.

The interface unit 1008 is served as an interface for connecting an external device to the electronic device 1000. For example, the external device may include a wired or wireless headset port, an external power (or a battery charger) port, a wired or wireless data port, a memory card port, a port for connecting devices with identification modules, an audio input/output (input/output) port, a video input/output port, a headphone port, and the like. The interface unit 1008 may be used for receiving input (for example, data information, power, and the like) from the external device and transmitting received input to one or more components in the electronic device 1000, or it may be used for data transmission between the electronic device 1000 and the external device.

The memory 1009 may be used for storing software programs and various data. The memory 1009 may mainly include a program storage area and a data storage area. The program storage area may store an operating system, an application program required for at least one function (such as sound playback function, image playback function), and the like. The data storage area may store data (such as audio data, phonebook, and the like) created based on the use of a mobile phone. Additionally, the memory 1009 may include high-speed random-access memory and may also include non-volatile memory, such as at least one disk storage device, a flash memory device, or other volatile solid-state storage devices.

The processor 1010 is a control center of the electronic device. It connects various parts of the entire electronic device via various interfaces and lines, and performs various functions and data processing of the electronic device by running or executing software programs and/or modules stored in the memory 1009, and calling data stored in the memory 1009, thereby performing overall monitoring of the electronic device. The processor 1010 may include one or more processing units. Preferably, the processor 1010 may integrate an application processor and a modem processor, where the application processor mainly handles an operating system, a user interface, and application programs, and the modem processor mainly handles wireless communication. It is understandable that the aforementioned modem processor may also not be integrated into the processor 1010.

The electronic device 1000 may also include a power supply 1011 (such as a battery) that supplies power to various components. Preferably, the power supply 1011 may be logically connected to the processor 1010 via a power management system, thereby enabling functions such as charging management, discharging management, and power consumption management through the power management system.

Additionally, the electronic device 1000 includes some functional modules not shown, which are not be repeated herein.

It should be noted that in this document, terms “include”, “comprise” or any other variations thereof are intended to cover non-exclusive inclusion, so that a process, a method, an article, or an apparatus that includes a series of elements not only includes those elements but also includes other elements not explicitly listed, or elements inherent to such process, method, article, or apparatus. Without further limitation, an element defined by a phrase “includes a . . . ” does not exclude the existence of additional identical elements in the process, the method, the article, or the apparatus that includes the element.

Through the description of the above embodiments, those skilled in the art may clearly understand that methods of the above embodiments may be implemented by means of software plus a necessary general hardware platform, and of course, they may also be implemented by hardware. However, in many cases, the former is a better implementation. Based on this understanding, the technical solutions of the present disclosure, in essence or a part contributing to the prior art, may be embodied in a form of a software product. The computer software product is stored in a storage medium (such as ROM/RAM, a magnetic disk, an optical disc) and includes several instructions to enable a terminal (which may be a mobile phone, a computer, a server, an air conditioner, or a network device, and the like) to execute the methods described in various embodiments of the present disclosure.

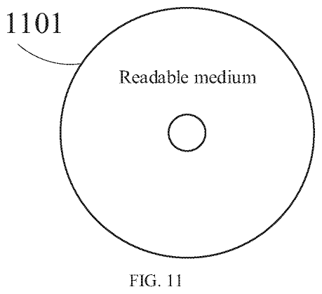

As shown in FIG. 11, in another embodiment according to the present disclosure, a computer-readable storage medium 1101 is also provided. Instructions are stored on the computer-readable storage medium, and when executed on a computer, the instructions cause the computer to execute the method for constructing the hybrid virtual device described in the above embodiments.

The embodiments of the present disclosure have been described above in conjunction with the drawings, but the present disclosure is not limited to the specific implementations described above. The specific implementations described above are merely illustrative and not restrictive. Under the enlightenment of the present disclosure, those of ordinary skill in the art may make many modifications without departing from the purpose of the present disclosure and the scope protected by the claims, and all of such modifications fall within the protection scope of the present disclosure.

Those of ordinary skill in the art may realize that units and algorithm steps of the examples described in conjunction with the embodiments disclosed in the present disclosure may be implemented by electronic hardware, or a combination of computer software and electronic hardware. Whether these functions are performed by hardware or software depends on specific application and design constraints of the technical solution. Professionals may use different methods for each specific application to implement described functions, but such implementation should not be considered beyond the scope of the present disclosure.

Those skilled in the art may clearly understand that, for convenience and brevity of description, specific working processes of the system, the apparatus, and the units described above may refer to corresponding processes in the aforementioned method embodiments and are not be repeated herein.

In the embodiments provided by the present disclosure, it should be understood that the disclosed apparatuses and methods may be implemented in other manners. For example, the apparatus embodiments described above are merely illustrative. For example, division of the units is only a logical function division, and in actual implementation, there may be other division methods. For example, a plurality of units or components may be combined or integrated into another system, or some features may be ignored or not executed. Additionally, shown or discussed mutual couplings or direct couplings or communication connections may be indirect couplings or communication connections through some interfaces, apparatuses, or units, which may be electrical, mechanical, or other forms.

Units described as separate components may or may not be physically separated. The components shown as units may or may not be physical units, meaning they may be located in one place or distributed across a plurality of network units. Some or all of the units may be selected according to actual needs to achieve the purpose of the embodiments.

Furthermore, functional units in various embodiments of the present disclosure may be integrated into a processing unit, or each unit may exist physically alone, or two or more units may be integrated into a unit.

If functions are implemented in a form of software functional units and sold or used as independent products, they may be stored in a computer-readable storage medium. Based on this understanding, the technical solutions of the present disclosure, in essence or the part contributing to the prior art, or part of the technical solutions, may be embodied in the form of a software product. This computer software product is stored in a storage medium and includes several instructions to enable a computer device (which may be a personal computer, a server, or a network device, and the like) to execute all or part of the steps of the methods described in various embodiments of the present disclosure. The aforementioned storage medium includes various media that may store program codes, such as a U disk, a mobile hard drive, ROM, RAM, a magnetic disk, or an optical disc.

The above descriptions are only specific implementations of the present disclosure, but the protection scope of the present disclosure is not limited to this. Any person skilled in the art may easily think of changes or substitutions within the technical scope disclosed by the present disclosure, which should fall within the protection scope of the present disclosure. Therefore, the protection scope of the present disclosure should be subject to the protection scope of the claims.

What is claimed is:

1. A method for constructing a hybrid virtual device, comprising:
determining a data source type and determining a starting input and output module based on the data source type;
determining a functional module;
determining an output data type and determining a terminal input and output module based on the output data type;
adopting the starting input and output module, the functional module, and the terminal input and output module to generate a plurality of independent virtual devices; and
adopting the plurality of independent virtual devices to construct the hybrid virtual device.

2. The method according to claim 1, further comprising:
constructing a data source module configuration parameter table, an intermediate node module configuration parameter table, and a data sink module configuration parameter table for the plurality of independent virtual devices;
determining a data source module configuration parameter for the starting input and output module, and writing the data source module configuration parameter into the data source module configuration parameter table;
when the functional module is a peripheral module, determining an intermediate node module configuration parameter for expressing an input and output data format of the functional module, and writing the intermediate node module configuration parameter into the intermediate node module configuration parameter table;
determining a data sink module configuration parameter for the terminal input and output module, and writing the data sink module configuration parameter into the data sink module configuration parameter table; and
starting the hybrid virtual device.

3. The method according to claim 2, wherein the hybrid virtual device is provided with a bus arbiter, each of the plurality of independent virtual devices is provided with a corresponding device identifier, the functional module is provided with a corresponding input data buffer memory, and the method further comprises:
when input data for a target virtual device is detected, reading a target data source module configuration parameter corresponding to the target virtual device from the data source module configuration parameter table based on a target device identifier corresponding to the target virtual device;
determining a target functional module corresponding to the target virtual device based on the target device identifier;
acquiring the input data based on the target data source module configuration parameter; and
storing the input data into a target input data buffer memory corresponding to the target functional module via the bus arbiter.

4. The method according to claim 3, further comprising:
acquiring a status parameter for the target input data buffer memory;
when it is determined based on the status parameter that a storage amount of the target input data buffer memory exceeds a first preset threshold, adjusting the target functional module up to a first frequency using a primary frequency multiplication coefficient;
when it is determined based on the status parameter that the storage amount of the target input data buffer memory exceeds a second preset threshold, adjusting the target functional module up to a second frequency using a secondary frequency multiplication coefficient, wherein the second frequency is higher than the first frequency; and
when it is determined based on the status parameter that the storage amount of the target input data buffer memory exceeds a third preset threshold, adjusting the target functional module up to a highest frequency using a tertiary frequency multiplication coefficient.

5. The method according to claim 4, wherein the target functional module is configured with a corresponding pipeline configuration table, and the method further comprises:
when the target functional module finishes processing the input data, sending output request information to the bus arbiter, wherein the output request information comprises the target device identifier and output packet length information for a data packet of the input data;
determining a next-level functional module identifier of a next-level functional module corresponding to the target functional module in the pipeline configuration table via the bus arbiter based on the target device identifier and a target functional module identifier of a currently requesting target functional module, wherein the next-level functional module has a corresponding to-be-processed data sequence, the to-be-processed data sequence is used for expressing an order of input data to be processed by the target functional module; and the input data has a corresponding priority identifier;
inserting the input data into the to-be-processed data sequence via the bus arbiter based on the priority identifier; and
storing the input data into a next-level input data buffer memory corresponding to the next-level functional module via the bus arbiter based on the to-be-processed data sequence.

6. The method according to claim 3, wherein the functional module is provided with an input port and an output port, and the functional module is connected to the input data buffer memory via the input port and the output port.

7. The method according to claim 5, wherein the functional module is configured with a corresponding state machine, and the method further comprises:
determining whether the input data buffer memory is empty; and
if it is determined that the input data buffer memory is not empty, performing a reset operation on the state machine.

8. The method according to claim 1, wherein the determining a starting input and output module based on the data source type comprises:
when the data source type is general-purpose input and output data, determining a chip pin input and output module as the starting input and output module; and
when the data source type is static random-access memory data, determining a direct memory access memory input and output module as the starting input and output module.

9. The method according to claim 1, wherein the determining a terminal input and output module based on the output data type comprises:
when the output data type is general-purpose input and output data, determining a chip pin input and output module as the terminal input and output module; and
when the output data type is static random-access memory data, determining a direct memory access memory input and output module as the terminal input and output module.

10. The method according to claim 2, wherein when the data source type is general-purpose input and output data, the data source module configuration parameter comprises: a sampling clock source, a clock frequency, and a filtering coefficient.

11. The method according to claim 2, wherein when the data source type is static random-access memory data, the data source module configuration parameter comprises: a data input address, a data length, a buffer threshold, and an interrupt signal.

12. An apparatus for constructing a hybrid virtual device, comprising:
a data source type determination module, configured to determine a data source type and determine a starting input and output module based on the data source type;
a functional module determination module, configured to determine a functional module;
an output data type determination module, configured to determine an output data type and determine a terminal input and output module based on the output data type;
an independent virtual device generation module, configured to adopt the starting input and output module, the functional module, and the terminal input and output module to generate a plurality of independent virtual devices; and
a hybrid virtual device construction module, configured to adopt the plurality of independent virtual devices to construct the hybrid virtual device.

13. An electronic device, comprising a processor, a communication interface, a memory, and a communication bus, wherein the processor, the communication interface, and the memory communicate with each other via the communication bus;
the memory is configured to store a computer program; and
the processor is configured to, when executing the program stored on the memory, implement a method for constructing a hybrid virtual device,
wherein the method comprises:
determining a data source type and determining a starting input and output module based on the data source type;
determining a functional module;
determining an output data type and determining a terminal input and output module based on the output data type;
adopting the starting input and output module, the functional module, and the terminal input and output module to generate a plurality of independent virtual devices; and
adopting the plurality of independent virtual devices to construct the hybrid virtual device.

14. The electronic device according to claim 13, wherein the method further comprises:
constructing a data source module configuration parameter table, an intermediate node module configuration parameter table, and a data sink module configuration parameter table for the plurality of independent virtual devices;
determining a data source module configuration parameter for the starting input and output module, and writing the data source module configuration parameter into the data source module configuration parameter table;
when the functional module is a peripheral module, determining an intermediate node module configuration parameter for expressing an input and output data format of the functional module, and writing the intermediate node module configuration parameter into the intermediate node module configuration parameter table;
determining a data sink module configuration parameter for the terminal input and output module, and writing the data sink module configuration parameter into the data sink module configuration parameter table; and
starting the hybrid virtual device.

15. The electronic device according to claim 14, wherein the hybrid virtual device is provided with a bus arbiter, each of the plurality of independent virtual devices is provided with a corresponding device identifier, the functional module is provided with a corresponding input data buffer memory, and the method further comprises:
when input data for a target virtual device is detected, reading a target data source module configuration parameter corresponding to the target virtual device from the data source module configuration parameter table based on a target device identifier corresponding to the target virtual device;
determining a target functional module corresponding to the target virtual device based on the target device identifier;
acquiring the input data based on the target data source module configuration parameter; and
storing the input data into a target input data buffer memory corresponding to the target functional module via the bus arbiter.

16. The electronic device according to claim 15, wherein the method further comprises:
acquiring a status parameter for the target input data buffer memory;
when it is determined based on the status parameter that a storage amount of the target input data buffer memory exceeds a first preset threshold, adjusting the target functional module up to a first frequency using a primary frequency multiplication coefficient;
when it is determined based on the status parameter that the storage amount of the target input data buffer memory exceeds a second preset threshold, adjusting the target functional module up to a second frequency using a secondary frequency multiplication coefficient, wherein the second frequency is higher than the first frequency; and
when it is determined based on the status parameter that the storage amount of the target input data buffer memory exceeds a third preset threshold, adjusting the target functional module up to a highest frequency using a tertiary frequency multiplication coefficient.

17. The electronic device according to claim 16, wherein the target functional module is configured with a corresponding pipeline configuration table, and the method further comprises:
when the target functional module finishes processing the input data, sending output request information to the bus arbiter, wherein the output request information comprises the target device identifier and output packet length information for a data packet of the input data;
determining a next-level functional module identifier of a next-level functional module corresponding to the target functional module in the pipeline configuration table via the bus arbiter based on the target device identifier and a target functional module identifier of a currently requesting target functional module, wherein the next-level functional module has a corresponding to-be-processed data sequence, the to-be-processed data sequence is used for expressing an order of input data to be processed by the target functional module; and the input data has a corresponding priority identifier;
inserting the input data into the to-be-processed data sequence via the bus arbiter based on the priority identifier; and
storing the input data into a next-level input data buffer memory corresponding to the next-level functional module via the bus arbiter based on the to-be-processed data sequence.

18. The electronic device according to claim 15, wherein the functional module is provided with an input port and an output port, and the functional module is connected to the input data buffer memory via the input port and the output port.

19. The electronic device according to claim 17, wherein the functional module is configured with a corresponding state machine, and the method further comprises:
determining whether the input data buffer memory is empty; and
if it is determined that the input data buffer memory is not empty, performing a reset operation on the state machine.

20. A non-transitory computer-readable storage medium storing instructions, wherein the instructions, when executed by one or more processors, cause the processor to execute the method according to claim 1.
